(19) United States
(12) Patent Application Publication
(10) Pub. No.: US 2004/0144943 A1
(43) Pub. Date: Jul. 29, 2004

(54) Electromagnetically actuated proportional flow control system

(76) Inventor: William F. Everett, Goshen, IN (US)

Correspondence Address: Ryan M. Fountain, Esq., 420 Lincoln Way West, Mishawaka, IN, 46544, US

(21) Appl. No.: 10/351,673

(22) Filed: Jan. 28, 2003

(51) Int. Cl. F16K 31/02

(52) U.S. Cl. 251/129.07

(57) ABSTRACT

An electromagnetically actuated proportional flow control is provided, with an integral differential pressure regulator, that delivers constant fluid flow independent of input fluid supply pressure and output fluid back pressure in a force balanced spool and sleeve configuration. The force on the spool is controlled by a mechanical device and an electromagnetic device. The force on the spool from the electromagnetic device is variable according to changes in the fluid pressures, the applicable environment and the mechanical components of the system in order to create a the desired force balance on the spool. This arrangement may be used to create proportional fluid control for a single fluid, as for example in a fuel system, or multiple fluids, as for example in a beverage dispensing system.

### BACKGROUND AND SUMMARY OF THE INVENTION

The present invention relates to fluid flow control systems having differential pressure regulators and, more particularly, to beverage dispensing systems wherein a plurality of fluids are mixed in a given proportion, such as carbonated beverages.

There are a number of fluid flow systems in which it is desirable to control the fluid flow rate over a range of conditions both internal and external to the systems. In such systems it can be advantageous to throttle the flow of fluid proportionally to changing input signals. Such systems can employ a single fluid or be used to precisely ratio the flow of multiple fluids. One example of the latter type of system is in “post mix” beverage dispensing, where multiple fluids are stored separately and then mixed together at the point of dispensing to create the beverage.

In general, such beverage dispensing systems employ valves to meter the amount of carbonated water and syrup at prescribed fluid flows and ratios to produce a desired end product mix. Previously, these arrangements have included solenoid actuated valve ports and “spool and sleeve” differential pressure fluid flow regulators. These regulators have been mechanically adjusted and pre-set for a specific flow rate. In some cases, the regulators have been field adjustable, but are not part of a dynamic closed loop control system. Instead, they are part of a closed loop fluid flow control that is calibrated to a desired fluid flow rate, mechanically set and operate independent of external input.

One alternative approach has been to create a valve arrangement to control the fluid flow. This approach can be divided into two groups. The first is to use an on-off valve and to pulse the valve on and off as a function of on time in order to obtain the integrated total flow desired. The second is to use a proportional solenoid and stepper motor in order to obtain a variable total flow. This approach has required the use of a flow sensor in order to establish the desired metered fluid flow rate.

Another alternative approach has been to meter fluid flow by positive displacement of a piston. The actuation of the piston through repetitive strokes establishes the total desired fluid flow. Various means to actuate the piston have been accomplished using additional flow control solenoids or by actuating the piston with the supply pressure from the controlled fluid.

In such designs, the intent of the beverage dispenser is to control the amount of syrup and the amount of water in a dispensed serving such that the total flow rate and the ratio of the constituents of the flow are controlled to a level of desired accuracy. The uncontrolled variables that affect the desired level of accuracy are often the input supply pressure of the fluids, the temperatures of the fluids over time and the available flow capacity of the upstream delivery lines and manifolds (heat exchangers). These uncontrolled variables are often what lead to a less than desired degree of performance and quality that are measured typically by the accuracy of the syrup-to-water ratio. For example, the consumer at a busy restaurant may notice a difference in beverage taste from a beverage obtained immediately before and immediately after lunch.

The field adjustability of prior systems allows for some degree of compensation for these shortcomings and environmental variations, but does not provide for closed loop control that would result from a dynamic control to continuously compensate for the changing supply and environmental conditions. Pulsed flow occurs in positive displacement types of fluid control technology, but has resulted in a beverage presentation that is undesirable, and can result in an incomplete mixture of the dispensed fluids. Pulsed on-off flow can also be achieved in solenoid actuated flow control designs, but also can result in undesirable beverage presentation and incomplete mixture of the fluids. For example, such prior systems can result in audible or mechanical oscillations at the point of dispensing. Also, prior stepper motor designs cannot actuate or change flow settings due to the magnitude of the transient displacement require from some off to on settings, as, for example, when the dispenser is momentarily actuated in an attempt to “top-off” a beverage serving. Similarly, prior systems that utilize a volumetric displacement method cannot always control small volumes of fluid flow to a desired ratio of fluid dispensed due to an incremental pulse of fluid (the smallest resolvable flow increment).

Accordingly, it is an object of the present invention to provide an improved valve arrangement, and more particularly, a valve arrangement which:

1. Provides proportional fluid flow control,

2. Integrates flow regulation and proportional electromagnetic actuation,

3. Provides an output fluid flow rate that is independent of inlet pressure and outlet pressure within the limits of a usable supply pressure, output pressure and delivery flow,

4. Dispenses mixed component beverages at a desired component ratio independent of environmental changes and system component changes,

5. Includes a differential pressure regulator having a dynamic, closed loop control to compensate for changing conditions.

6. Is compact and of simplified construction, with common components for various different fluids,

7. Is relatively inexpensive to manufacture and to service and maintain during operation, and

8. Is reliable in operation over long periods of use.

These and other advantages are obtained by the use of an electromagnetically actuated proportional flow control, with an integral differential pressure regulator, that delivers constant fluid flow independent of input fluid supply pressure and output fluid back pressure in a force balanced spool and sleeve configuration. The force on the spool is controlled by a mechanical device and an electromagnetic device. The force on the spool from the electromagnetic device is variable according to changes in the fluid pressures, the applicable environment and the mechanical components of the system in order to create a the desired force balance on the spool. This arrangement may be used to create proportional fluid control for a single fluid, as for example in a fuel system, or multiple fluids, as for example in a beverage dispensing system.

Other objects, advantages and novel features of the present invention will readily become apparent to those skilled in the pertinent art from the following drawings and detailed description.

### BRIEF DESCRIPTION OF THE DRAWINGS

FIG. 1 shows in schematic form a beverage dispensing system incorporating the present invention.

FIG. 2 shows a cross sectional view of the valve arrangement of FIG. 1.

### DESCRIPTION OF PREFERRED EMBODIMENTS

The present invention provides a force balanced, differential pressure regulator that can be used in a number of different applications. For purposes of illustration, one such application is in post mix dispensing of beverages.

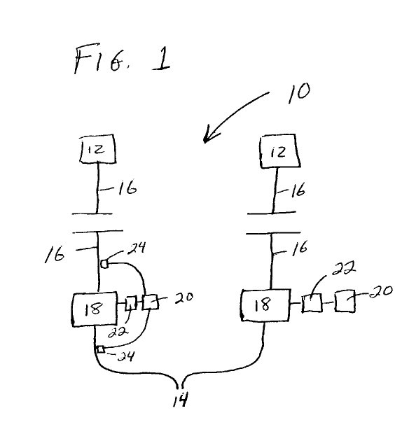

FIG. 1 shows a beverage dispensing system 10 according to the teachings of the present invention. System 10 includes at least two supplies 12 of fluid to be mixed together at an output point 14. Supplies 12 can be located substantially remote from output point 14 and are connected thereto by fluid lines 16. A valve arrangement 18 is mounted within at least one of fluid lines 16 to meter the volume of the fluid passing through that line. Valve arrangement 18 is preferably mounted close to outlet point 14. A control circuit 20 is connected to valve arrangement 18 and includes a digital driver 22 of conventional construction. Control circuit 20 receives input signals from various sensors 24 connected to the fluid lines as desired, both upstream and downstream of valve arrangement 18.

The circuit of digital driver 22, creates, for example PWM signals (pulse width modulated signals) in a conventional manner. One such suitable driver would be a Digital Valve Driver Model DVD, P/N BD-102-100PP, available from Hydro Electronic Devices, Inc. of Hartford, Wis. Similarly, a variety of conventional sensor devices to monitor fluid flow rate, temperature and pressure can be employed as sensors 24. Also, a standard hydraulic actuator valve circuit, such as an Electronic Interface Control Model EC0003, available from Brand Hydraulics, Inc. of Omaha, Nebr., can be employed as control circuit 20 to create the force balance and dither action on valve arrangement 18 as described further below.

Valve arrangement 18 includes, for example, a PWM solenoid valve designed to provide a uniform, continuous flow of dispensed fluid. When used in conjunction with one or more similar units, the combined total flow with appropriate ratios of dispensed fluid can be achieve and controlled. In general, valve arrangement 18 integrates flow regulation and proportional electromagnetic actuation together to affect an electrically variable proportional fluid flow. The output flow is independent of inlet fluid pressure and outlet fluid pressure, or backpressure, within the limits of the usable fluid supply pressure, outlet pressure and delivery flow. Integral differential pressure regulation changes with electrical signal input, and that differential pressure occurs across a fixed internal restriction or orifice.

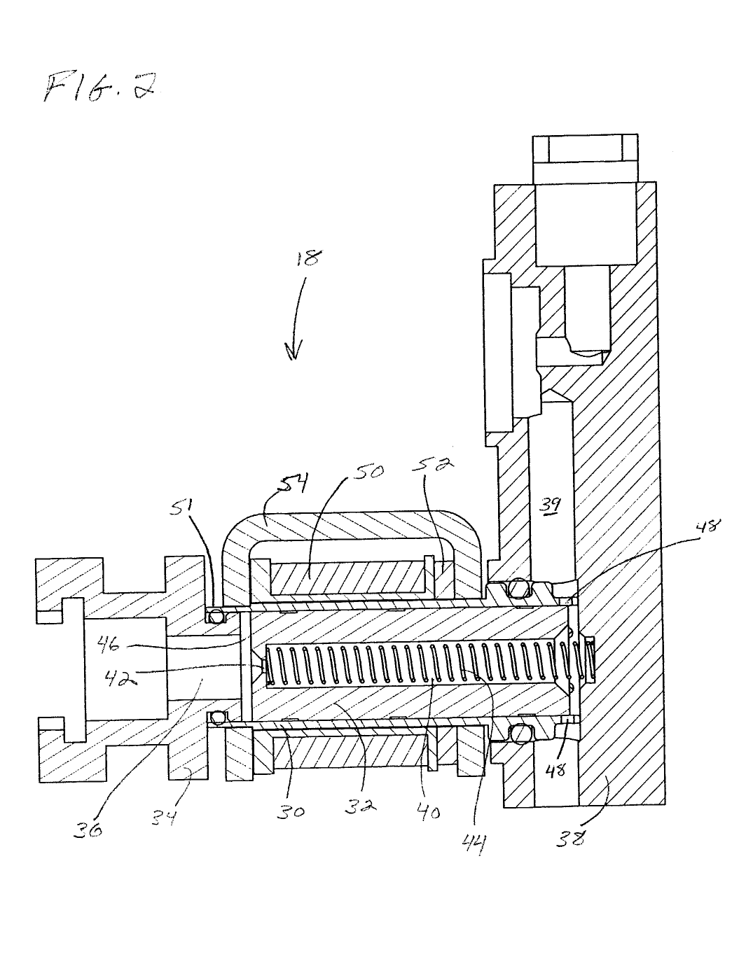

As shown in FIG. 2, valve arrangement 18 includes a sleeve 30 with a spool 32 slidably mounted therein as a fluid flow regulator. Sleeve 30 is connected between fluid supply inlet conduit 34, having fluid passageway 36 therein, and fluid outlet port or dispenser housing 38. By way of orientation, a conventional dispenser shut off valve (not illustrated), such as a solenoid valve, to terminate flow upon completion of dispensing can be mounted to housing 38 downstream of valve arrangement 18. Spool 32 includes a fluid passageway 40 therethrough from a restrictor orifice 42 leading to conduit 34. The spool and sleeve serve as a pressure regulator to control the differential pressure across orifice 42 between conduit 34 and passageway 40. In applications such as beverage dispensing, the controlled fluids are considered to be substantially incompressible. Thus, the amount of fluid passing through orifice 42 is proportional to the differential pressure across the orifice.

Spring 44 is mounted to apply a balancing force to one side of spool 32, opposing the force created by the fluid flow on spool 32 (the differential pressure times the exposed area of the end face 46 of spool 32). As will be generally understood by those skilled in the art, increased flow through orifice 42 is proportionate to the differential pressure (input pressure from conduit 34 at passageway 36 minus output pressure in passageway 40) as related by Bernoulli's equation. When the force of excess pressure across spool 32, as applied to end face 46, causes the spool to move to the right (downstream in this orientation), the spool will begin to close off vent holes 48 in sleeve 30. These vent holes permit passage of the fluid from passageway 40 downstream to outlet port 39. As spool 32 starts to close vent holes 48, the fluid flow through the vent holes is reduced. This creates inherent pressure feedback that reduces the differential pressure across orifice 42. Therefore, this portion of valve arrangement 18 serves as a differential pressure regulator, controlling the fluid flow at a fixed level in relation to the initial load of spring 44. Accordingly, the inlet fluid pressure or the outlet downstream pressure can vary over any normal operating range consistent with the design intent of a particular application and the relationship between the inlet pressure, the spool passageway pressure, the resultant differential pressure, the orifice and the spring load remains unchanged. Thus, the fluid fiow rate can remain constant.

Valve arrangement 18 includes, however, several additional features to allow for electrical input that affects the rate of fluid flow therethrough. Wire coil 50 is mounted about sleeve 30. Washer 52 is mounted about sleeve 30 downstream of coil 50. Bracket 54 is mounted about sleeve 30 to contain coil 50 and washer 52. Washer 52 and bracket 54 are, for example, selected to be made from magnetic metal alloys so as to complete a magnetic circuit. Spool 32 is preferably formed from a material of magnetic quality, such as 430 Stainless Steel. Sleeve 30 is preferably formed from a non-magnetic material such as ceramic. Thus, when electric current is applied to coil 50, an electromagnetic field can be imparted on spool 32. The force from this field is generated between end face 46 and bracket 54 such that increasing the current to coil 50 will increase the force on the spool in the direction urged by spring 44. Therefore, the force balance on spool 32 between the differential fluid pressure force and the spring load, and the fluid flow therethrough, can be regulated according to the coil current as well.

Further, the current applied to coil 50 is controlled via the digital driver circuit with a pulsed electrical signal. A common description of such pulsed electrical signals is called pulse width modulation (PWM). A signal suitable for valve arrangement 18 in the present example is operated at a frequency of approximately 40 Hertz, although other frequencies can be used in other embodiments of the present invention as suited for particular fluids and applications. In the present example, the PWM signal is established such that the magnitude of the signal will impart a dither action on spool 32. Previously, dither actions have been known to be used in hydraulic actuators merely to move the position of an element. In the present application, however, this dither action is being used to create a proportional force balance. In the present application, by means of conventional control techniques, the magnitude of the dither and the frequency of the signal to the coil can be adjusted to effectively eliminate any significant inherent friction or “stiction” between spool 32 and sleeve 30. As the pulse width is modulated from 0% to 100% on-time, the average total integrated energy applied to the coils increases. Therefore, the percentage on-time of the PWM signal will be proportionate to the fluid flow through orifice 42.

Conventional controls can be applied to modulate the PWM signal to coil 50 according to signals from sensors 24 to control circuit 20. In this manner, a closed loop control can be created to maintain the desired fluid flow rate regardless of changes in inlet fluid pressure (as for example when syrup containers start to run low on fluid) or temperature changes (as for example when the dispenser has been operational for long periods of time without refreshing the fluid coolant, typically ice) or fluid viscosity and density changes, etc.

Summarizing then, the present invention provides a differential flow regulator function utilizing a force balanced spool and sleeve design with the total force exerted on the spool being the sum of the spring and the electromagnetic force created by the coil. The input electrical signal to the coils is directly proportional to the force on the spool. The total force on the spool is directly proportional to the differential pressure through the orifice, which is in turn proportional to the throughtput fluid flow rate. The dither action applied to the spool eliminates any significant drag, friction or inherent non-repeatability in function, as for example can be created by long term fatigue, deterioration or contamination of the spring force. Thus, also, replacement springs are not needed to change the set point to obtain low, medium or high dispensing rates in given applications. Flow is continuous with the present invention, without significant discontinuity or interruption and without obvious audible or mechanical oscillation. Compensation of force to maintain the desired fluid flow rates is faster than with prior designs since the electromagnetic force changes are imparted nearly instantaneously. Transient displacements to top-off applications are readily accommodated.

Although the present invention has been described above in detail with respect to preferred embodiments, the same is by way of illustration and example only and not by way if limitation. For example, various magnetic circuits can be employed to impart force to spool 32. Washers at either end of coil 50 can be used. Sleeve 30 need not have a stepped down end portion 51. Another form of mechanical or hydraulic force can be applied to spool 32 instead of or supplemental to spring 44. Further, the present invention can be applied to various other applications besides beverage dispensing. Accordingly, the spirit and scope of the present invention are limited only by the terms of the following claims.

What is claimed is:

1. A system for dispensing beverage comprising a plurality of fluids mixed together to produce the beverage, the volume of at least one of those fluids being controlled by a electromagnetically actuated, proportional flow control valve assembly which provides the fluid at a constant output flow rate despite a given range of input and output pressure conditions.

2. The system according to claim 1 which also compensates for variable fluid temperatures and system component deterioration.

3. An electromagnetically variable, differential pressure regulator that delivers fluid at a constant flow rate independent of input fluid supply pressure and output fluid backpressure.

4. The pressure regulator according to claim 3 including a force balanced spool and sleeve configuration.

5. A valve arrangement comprising:
a differential pressure regulator,
a means for modifying the operation of the differential pressure regulator in response to pulsed electrical signals, and
a means for controlling the pulsed electrical signals in response to changing characteristics of a fluid or the structure of the differential pressure regulator.

6. The valve arrangement according to claim 5 wherein the differential pressure regulator includes a sleeve member with a spool member movably mounted therein.

7. A valve arrangement comprising:
a passageway for fluid flow therethrough,
a sleeve,
a spool having a fluid path therethrough and slidably mounted within the sleeve and interrupting the fluid passageway,
an orifice in the spool permitting fluid flow from the passageway to the path,
a biasing arrangement providing mechanical force to the spool to urge the spool against the differential pressure created by the flow of fluid in the passageway,
an actuator providing electromagnetic force to the spool to alter the net force balance on motion of the spool to create a constant fluid flow rate through the orifice.

8. The valve arrangement according to claim 7 wherein the actuator is responsive to pulsed electrical signals.

9. The valve arrangement according to claim 8 wherein the pulsed electrical signals impart a dither action to the spool movement, depending upon the magnitude of the signals, to create a force balance on the spool.

10. The valve arrangement according to claim 7 wherein
the actuator includes a coil mounted about at least a portion of the sleeve,
pulse with modulated electrical signals are applied to the coil by a digital drive circuit, and
fluid flow sensors provide control signals to the drive circuit to alter output of the drive circuit according to changes in the fluid flow through the valve arrangement.
